(19) United States
(12) Patent Application Publication
(10) Pub. No.: US 2024/0210712 A1
(43) Pub. Date: Jun. 27, 2024

(54) Systems With Position Sensors

(71) Applicant: Apple Inc., Cupertino, CA (US)

(72) Inventors: Darshan R Kasar, Redwood City, CA (US); Christopher Patton, San Jose, CA (US); Dominic P Cincione, San Francisco, CA (US); Ivan S Maric, Campbell, CA (US); Nicholas C Soldner, Los Altos, CA (US)

(21) Appl. No.: 18/435,103

(22) Filed: Feb. 7, 2024

Related U.S. Application Data
(63) Continuation of application No. PCT/US22/39874, filed on Aug. 9, 2022.
(60) Provisional application No. 63/235,357, filed on Aug. 20, 2021.

(51) Int. Cl. G02B 27/01; G01C 21/16; G06T 3/18; G06T 5/80

(52) U.S. Cl. CPC G02B 27/0179; G01C 21/16; G02B 27/0172; G06T 3/18; G06T 5/80; G02B 2027/0178

(57) ABSTRACT

A head-mounted device such as a pair of glasses may have a head-mounted housing. The head-mounted device may include displays such as projector displays and may include associated optical components. The optical components may include waveguides that are used in providing images received from the displays to corresponding eye boxes for viewing by a user. Changes in the relative orientation between the displays and waveguides may warp the images in the eye boxes. To compensate for this effect, control circuitry in the head-mounted device may use position sensors to measure the relative positions of the displays and waveguides. Image warping due to misalignment between the displays and waveguides may be removed by applying compensating image warping to the images being produced by the displays.

This application is a continuation of international patent application No. PCT/US2022/039874, filed Aug. 9, 2022, which claims priority to U.S. provisional patent application No. 63/235,357, filed Aug. 20, 2021, which are hereby incorporated by reference herein in their entireties.

### FIELD

This relates generally to electronic devices, and, more particularly, to electronic devices such as head-mounted devices.

### BACKGROUND

Electronic devices have components such as displays and other optical components. During operation, there is a risk that components may become misaligned with respect to each other due to drop events and other undesired high-stress events. This poses challenges for ensuring satisfactory component performance.

### SUMMARY

A head-mounted device such as a pair of glasses may have a head-mounted housing. The head-mounted device may include displays such as projector displays and may include associated optical components. The optical components may include waveguides that are used in providing images received from the displays to corresponding eye boxes for viewing by a user.

Changes in the relative orientation between the displays and waveguides may warp the images in the eye boxes. To compensate for this effect, control circuitry in the head-mounted device may use position sensors to measure the relative positions of the displays and waveguides. Image warping due to measured misalignment between the displays and waveguides may then be removed by applying compensating image warping to the images being produced by the displays.

The head-mounted device may operate in a system that includes additional devices such as peripheral devices (peripherals) with position sensors. A peripheral device position sensor (peripheral position sensor) may measure the position of the peripheral device and this information may be wirelessly transmitted to the head-mounted device. The head-mounted device may update visual content being presented to a user by the displays of the head-mounted device based at least partly on the measured position of the peripheral device. For example, as a user rotates the peripheral device, the head-mounted device may use the displays to present visual content in which a corresponding virtual object being viewed by the user is rotated by a corresponding amount.

### BRIEF DESCRIPTION OF THE DRAWINGS

FIG. 1 is a diagram of an illustrative system in accordance with an embodiment.

FIG. 2 is a top view of an illustrative head-mounted device in accordance with an embodiment.

FIG. 3 is a diagram showing how component position can be measured using position sensors in accordance with an embodiment.

FIG. 4 is a cross-sectional view of a portion of a temple in illustrative glasses in accordance with an embodiment.

FIG. 5 is a flow chart of illustrative operations involved in using a system in accordance with an embodiment.

### DETAILED DESCRIPTION

A system may include one or more electronic devices. Each device may contain optical components and other components. During operation, the positions of these components and the devices may be monitored using position sensors. Using position information from the sensors and/or other sensor data, devices in the system may coordinate operation, may perform calibration operations to compensate for measured component misalignment, and/or may take other actions.

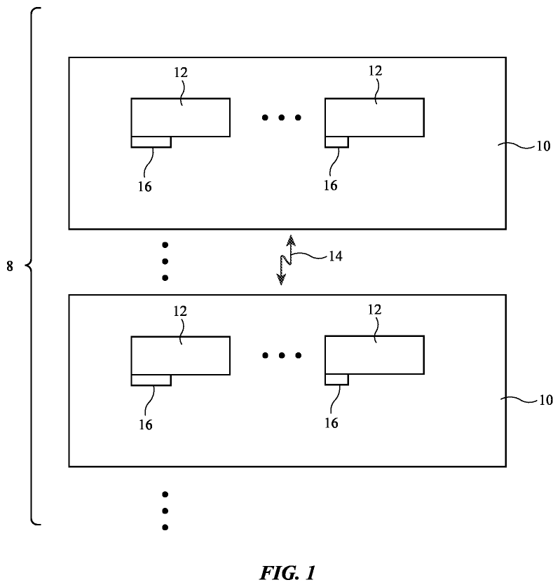

FIG. 1 is a schematic diagram of an illustrative system of the type that may include one or more electronic devices with position sensors. As shown in FIG. 1, system 8 may include electronic devices 10. Devices 10 may include head-mounted devices (e.g., goggles, glasses, helmets, and/or other head-mounted devices), cellular telephones, tablet computers, peripheral devices (sometimes referred to as peripherals) such as headphones, game controllers, and/or other input devices. Devices 10 may, if desired, include laptop computers, computer monitors containing embedded computers, desktop computers, media players, or other handheld or portable electronic devices, smaller devices such as wristwatch devices, pendant devices, ear buds, or other wearable or miniature devices, televisions, computer displays that do not contain embedded computers, gaming devices, remote controls, embedded systems such as systems in which equipment is mounted in a kiosk, in an automobile, airplane, or other vehicle, removable external cases for electronic equipment, straps, wrist bands or head bands, removable covers for electronic devices, cases or bags that receive and carry electronic equipment and other items, necklaces or arm bands, wallets, sleeves, pockets, or other structures into which electronic equipment or other items may be inserted, part of an item of clothing or other wearable item (e.g., a hat, belt, wrist band, headband, sock, glove, shirt, pants, etc.), or equipment that implements the functionality of two or more of these devices.

With one illustrative configuration, which may sometimes be described herein as an example, system 8 includes a head-mounted device such as a pair of glasses (sometimes referred to as augmented reality glasses). System 8 may also include peripherals such as headphones, game controllers, and/or other input-output devices (as examples). In some scenarios, system 8 may include one or more stand-alone devices 10. In other scenarios, multiple devices 10 in system 8 exchange information using wired and/or wireless links, which allows these devices 10 to be used together. For example, a first of devices 10 may gather user input or other input that is used to control a second of devices 10 (e.g., the first device may be a controller for the second device). As another example, a first of devices 10 may gather input that is used in controlling a second device 10 that, in turn, displays content on a third device 10.

Devices 10 may include components 12. Components 12 may include control circuitry. The control circuitry may include storage and processing circuitry for supporting the operation of system 8. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in the control circuitry may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc.

To support communications between devices 10 and/or to support communications between equipment in system 8 and external electronic equipment, devices 10 may include wired and/or wireless communications circuitry. The communications circuitry of devices 10, which may sometimes be referred to as control circuitry and/or control and communications circuitry, may include antennas, radio-frequency transceiver circuitry, and other wireless communications circuitry and/or wired communications circuitry. The communications circuitry of devices 10 may, for example, support bidirectional wireless communications between devices 10 over wireless links such as wireless link 14 (e.g., a wireless local area network link, a near-field communications link, or other suitable wired or wireless communications link (e.g., a Bluetooth® link, a WiFi® link, a 60 GHz link or other millimeter wave link, etc.). Components 12 may also include power circuits for transmitting and/or receiving wired and/or wireless power and may include batteries.

Components 12 may include input-output devices. The input-output devices may be used in gathering user input, in gathering information on the environment surrounding the user, and/or in providing a user with output. The input-output devices may include sensors such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, and/or other sensors. In some arrangements, devices 10 may use sensors and/or other input-output devices to gather user input (e.g., buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.).

Components 12 may include haptic output devices. The haptic output devices can produce motion that is sensed by the user (e.g., through the user's head, hands, or other body parts). Haptic output devices may include actuators such as electromagnetic actuators, motors, piezoelectric actuators, electroactive polymer actuators, vibrators, linear actuators, rotational actuators, actuators that bend bendable members, etc.

If desired, input-output devices in components 12 may include other devices such as displays (e.g., to display images for a user), status indicator lights (e.g., a light-emitting diode that serves as a power indicator, and other light-based output devices), speakers and other audio output devices, electromagnets, permanent magnets, structures formed from magnetic material (e.g., iron bars or other ferromagnetic members that are attracted to magnets such as electromagnets and/or permanent magnets), etc.

As shown in FIG. 1, sensors such as position sensors 16 may be mounted to one or more of components 12. Position sensors 16 may include accelerometers, magnetic sensors such as compass sensors, gyroscopes, and/or inertial measurement units that contain some or all of these sensors. Sensors 16 may be used to measure location (e.g., location along X, Y, and Z axes), orientation (e.g., angular orientation around the X, Y, and Z axes), and/or motion (changes in location and/or orientation as a function of time). Sensors such as sensors 16 that can measure location, orientation, and/or motion may sometimes be referred to herein as position sensors, motion sensors, and/or orientation sensors.

Devices 10 may use sensors 16 to monitor the position (e.g., location, orientation, motion, etc.) of devices 10 in real time. This information may be used in controlling one or more devices 10 in system 8. As an example, a user may use a first of devices 10 as a controller. By changing the position of the first device, the user may control a second of devices 10 (or a third of devices 10 that operates in conjunction with a second of devices 10). As an example, a first device may be used as a game controller that supplies user commands to a second device that is displaying an interactive game.

Devices 10 may also use sensors 16 to detect any changes in position of components 12 with respect to the housings and other structures of devices 10 and/or with respect to each other. For example, a given one of devices 10 may use a first sensor 16 to measure the position of a first of components 12 and may use a second sensor 16 to measure the position of a second of components 12. By comparing the measured positions of the first and second components (and/or by using additional sensor data), device 10 can determine whether calibration operations and/or other operations in device 10 should be performed.

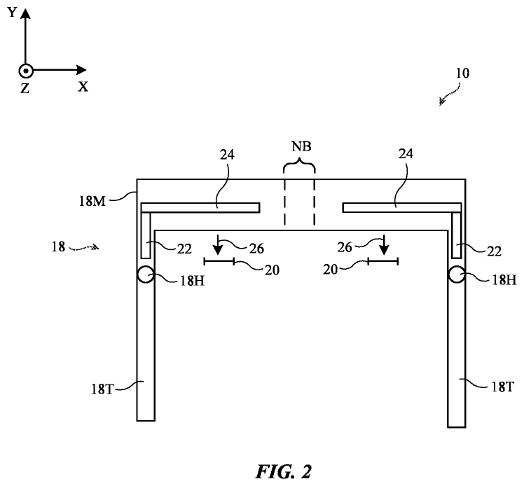

In an illustrative configuration, devices 10 include a head-mounted device such as a pair of glasses (sometimes referred to as augmented reality glasses). A top view of device 10 in an illustrative configuration in which device 10 is a pair of glasses is shown in FIG. 2. A shown in FIG. 2, device 10 may include housing 18. Housing 18 may include a main portion (sometimes referred to as a glasses frame) such as main portion 18M and temples 18T that are coupled to main portion 18M by hinges 18H. Nose bridge portion NB may have a recess that allows housing 18 to rest on a nose of a user while temples 18T rest on the user's ears.

Images may be displayed in eye boxes 20 using displays 22 (e.g., projector displays, sometimes referred to as light engines) and waveguides 24. Waveguides 24 may have input couplers that receive light from projector displays 22. This image light is then guided laterally (along the X axis) within waveguides 24 in accordance with the principal of total internal reflection. Each waveguide 24 may have an output coupler in front of a respective eye box 20. The output coupler couples the image light out of the waveguide 24 and directs an image towards the associated eye box 20 for viewing by a user (e.g., a user whose eyes are located in eye boxes 20), as shown by arrows 26. Input and output couplers for device 10 may be formed from gratings and/or other optical structures.

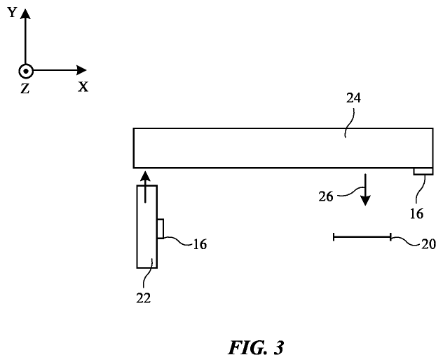

FIG. 3 is a diagram of an illustrative projector display 22 and an associated waveguide 24. As shown in FIG. 3, projector display (projector) 22 and waveguide 24 may be provided with respective position sensors 16. During operation, sensors 16 may be used to monitor the position of projector display 22 relative to waveguide 24. In the event that a thermally induced change and/or stress-induced misalignment causes projector display 22 to become misaligned with respect to waveguide 24, suitable action may be taken. If, as an example, it is determined that projector 22 is misaligned from its intended axis 26 by 2°, control circuitry in device 10 can conclude that the image supplied to eye box 20 will be distorted (e.g., the image will be warped and will exhibit keystoning) absent corrective action. Accordingly, when a 2° misalignment is measured, the control circuitry in device 10 can apply a corrective (equal and opposite) geometric transformation to the images being produced by projector display 22, thereby implementing a corrective image warping for the images being produced by display 22. This ensures that the images viewed by the user in eye box 20 will be free of geometric distortion due to the angular misalignment of display 22 relative to waveguide 24. In general, any image distortion due to measured misalignment may be corrected in this way (e.g., image translation, rotation, etc.).

If desired, data from additional sensors (e.g., visual inertial odometry sensors, structured light sensors, time of flight sensors, strain gauges that can measure housing bends and therefore component misalignment, etc.) may be used in combination with data from position sensors 16 (e.g., a sensor fusion arrangement may be used to enhance misalignment compensation accuracy and/or to otherwise improve the performance of operations using the position sensors). The use of position sensor data gathered by position sensors 16 coupled to components 12 such as display 22 and waveguide 24 may sometimes be described herein as an example. In general, however, any suitable operations may be performed using position sensor data and/or data from other sensors (e.g., control operations, etc.).

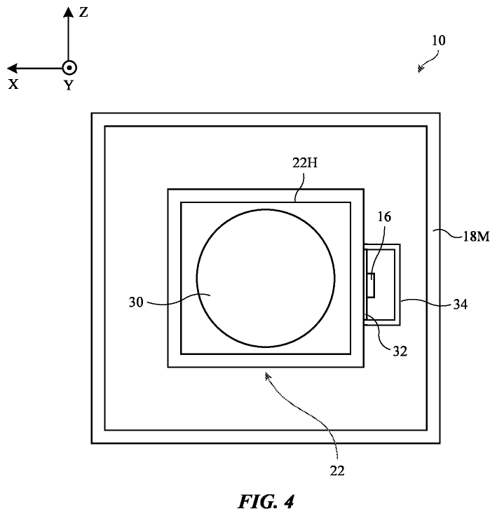

FIG. 4 is a cross-sectional view of device 10 taken through the housing walls of housing 18 (e.g., elongated portions of housing 18M that are adjacent to hinges 18H and aligned with temples 18T) and through sensor 16 and display 22. As shown in FIG. 4, display 22 may have a display housing such as display housing 22H (sometimes referred to as a projector package or projector housing). Display 22 may include an illumination source (e.g., one or more light-emitting diodes) and a pixel array (e.g., a reflective pixel array such as a mirror array) illuminated by the illumination source. An image from the pixel array (e.g., light reflected from the mirror array) is emitted into waveguide 24 (FIG. 3) through lens 30. Position sensor 16 may be mounted on a substrate such as printed circuit 32 that is attached to housing 22H (e.g., using adhesive or other attachment mechanism). Position sensor enclosure 34 (e.g., a metal can) may be used to provide sensor 16 with environmental protection. If desired, display 22 may be enclosed within a sealed package, housing 18M may be environmentally sealed and/or otherwise configured to provide display 22 and/or sensor 16 with environmental protection, and/or other housing structures and/or device packaging may be provided in device 10 to protect potentially sensitive components such as display 22 and/or sensor 16 from environmental exposure (e.g., moisture and dust). In a configuration in which sensor 16 is sealed for environmental protection within an interior portion of housing 18M (e.g., where housing 18M forms a sealed environmental protection enclosure for sensor 16), the walls of housing 18M may operate in conjunction with enclosure 34 and/or separately from enclosure 34 to help seal sensitive structures in sensor 16 from moisture absorption that could potentially lead to shifts in performance. In general, any suitable walls, enclosures, and/or other structures in device 10 that are formed from moisture-blocking materials such as glass, metal, and/or moisture-blocking polymer may be used in preventing moisture and humidity from reaching sensor 16. These structures may include portions of optical elements (sometimes referred to as optical structures, lenses, waveguides, etc.) in device 10 such as portions of a lens and/or waveguide 24 as shown in FIG. 3, may include walls in housing 18M as shown in FIG. 4, may include portions of display housing 22H as shown in FIG. 4, and/or may include other structures in device 10 that help prevent exposure of one or more portions of sensor 16 to moisture. By slowing or completely blocking the movement of moisture to sensor 16 in this way, the housing structures, optical elements, sensor enclosure structures and/or other structures in device 10 may help ensure that each sensor 16 in device 10 operates satisfactorily.

Device 10 may have any suitable number of position sensors 16. Sensors 16 may be mounted to displays, waveguides, other optical components, housing walls, non-optical electrical components, portions of components 12 (e.g., components such as a mirror array, a lens, a component package, a printed circuit, etc.) and/or other portions of device 10. As an example, left and right displays 22 in respective left and right portions of housing 18 may be provided with corresponding left and right position sensors 16. Device 10 may also have left and right position sensors attached to left and right waveguides 24. During operation, the position of each display may be compared to that of the waveguide to which the display supplies its image output, thereby allowing device 10 to detect any misalignment of the left display with respect to the left waveguide and to detect any misalignment of the right display with respect to the right waveguide. In response to detecting misalignment, corrective action may be taken. Corrective action may include alerting the user of device 10, using a positioner to realign relevant components in device 10, and applying digital image processing to the images output by displays 22 (e.g., to geometrically transform the output images to warp the images supplied to eye boxes 20 by an amount that compensates for any detected misalignment-induced image warping, etc.).

If desired, position sensor data may be shared among devices 10. As an example, a first of devices 10 may be a head-mounted device that is being worn on a user's head and a second of devices 10 may be used in controlling the first device. The first device may use displays 22 to display visual content such as computer-generated images for a user. Waveguides 24, which may have the shape of glasses lenses and/or which may be mounted on glasses lenses in front of a user's eyes, are preferably transparent from front-to-back, so that the user may view real-world objects in the environment surrounding the user by viewing the environment through the waveguides. At the same time, the output couplers on waveguides 24 may be used to extract image light from waveguides 24 that is associated with images from displays 22. In this way, a user may simultaneously view the real world and augmented (computer-generated) content that is overlaid on top of the real world. The second device may be a pair of headphones, a game controller, or other peripheral device that is used to gather input from the user and/or from the environment. The input may be used to control the first device. The second device may, as an example, have one or more position sensors 16 that detect the position of the second device and/or that detect the positions of components within the second device as the user moves the second device. Position information from the sensors in the second device and/or other sensor information may be conveyed from the second device to the first device over a wireless link. In an illustrative scenario, the user may move the second device to move items in a game or other program running on the first device, to select menu items presented by the first device, and/or to otherwise interact with and adjust the visual content (images) being presented to the user with the first device.

If desired, the position sensors in the first device may be used to detect the position of the first device and the displays within the first device (e.g., the positions of the left display and right display, including their orientations, which correspond to the left and right eyes of the user). The positions sensors in the second device may be used to determine the position of the second device with respect to the first device and the displays (“eyes”) of the first device. The user's gaze direction (sometimes referred to as the user's point of gaze) can be monitored using gaze tracking sensors in the first device and/or the general orientation of the user's head can be measured using the position sensors of the first device. Together, the measured position of the second device (e.g., the peripheral device) with respect to the user's gaze and orientation in augmented-reality space can be determined by the control circuitry of the system (e.g., the control circuitry of the first device), allowing enhanced user experiences to be created. As an example, audio output that is provided to the user with speakers in the first device may be adjusted based on the measured position of the peripheral device. As another example, consider a scenario in which the second device has a cubed-shaped housing or other hand-holdable housing shape. Position sensor(s) in the second device may gather information on the position of the second device in real time. Interaction (e.g., information sharing) between the position sensors in the first device (e.g., the head-mounted device) and the second device (e.g., the cube) may allow a user to interact with the cube in the real world, while a corresponding computer-generated object is presented to the user with the displays in the first device. As an example, a user may rotate the cube to rotate a computer-generated object that is being displayed with the first device. Motion of the cube relative to the orientation of the displays (and therefore the user's head orientation and direction of view) can be measured using position information gathered from position sensors in both the cube and in the head-mounted device.

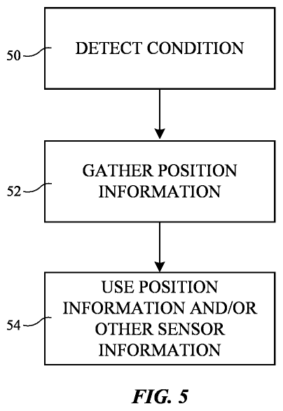

FIG. 5 is a flow chart of illustrative operations involved in using system 8. During the operations of block 50, devices 10 may monitor for conditions indicating that position information should be gathered using sensors 16. In some scenarios, sensors 16 may be used continuously (e.g., position measurements may be made repeatedly). In other situations, sensors 16 may be inactive until predetermined trigger conditions are detected, at which point the sensors may be powered up and used to make measurements. This approach may help reduce power consumption by allowing sensors 16 to be used only when position data is needed.

Devices 10 may, as an example, use an input device such as a touch sensor, microphone, button, or other input device to gather user input from a user (e.g., a user input command indicating that sensors 16 should gather position measurements so that the positions of displays 22 can be compared to the positions of associated waveguides 24 and/or so that other position data may be gathered). As another example, an accelerometer, force sensor, or other sensor may be used to detect when devices 10 have been subjected to a drop event or other event that imparts stress to device components (e.g., excessive stress that might cause component misalignment). Devices 10 can also use internal clocks in their control circuitry to measure the current time (e.g., to determine whether a predetermined time for making position sensor measurements has been reached). If desired, the operations of block 50 may be used to detect other conditions for triggering position sensor measurements (e.g., detecting when devices 10 have been placed within a storage case or have been removed from a storage case, detecting when device 10 is being powered on or powered off, detecting when wireless commands from another device 10 and/or remote equipment have been received, etc.). These criteria and/or other suitable position sensor measurement criteria may be used to determine when position measurements should be gathered.

In response to detecting a condition indicating that position measurements should be gathered, devices 10 may, during the operations of block 52, use position sensors 16 to make position measurements. If desired, position measurements may be made periodically (e.g., every X seconds, where X is at least 1 s, at least 10 s, at least 100 s, less than 500 s, less than 50 s, less than 5 s, or other suitable time period).

After position data from position sensors 16 has been gathered, this information may be used during the operations of block 54 (in conjunction with other sensor data in a sensor fusion arrangement, if desired). During block 54, the control circuitry of device(s) 10 may, for example, determine whether components have become misaligned due to a drop event or other event. In an illustrative configuration, the position of displays 22 relative to waveguides 24 may be measured to detect deviations from their desired angular orientations. Corrective action to recalibrate the optical systems of device(s) 10 may then be taken. For example, in response to determining that a display is misoriented with respect to a waveguide leading to undesired image warping, the control circuitry of a device may be used to apply a geometric transform to the images being output by the display. The geometric transform may create an equal and opposite amount of image warping, so that the images viewed in eye boxes 20 are free from misalignment-induced distortion.

As another example, visual content that is being displayed on a first device may be updated based, at least partly, on position information from a second device that is being used as a controller. A user may move the second device to move the virtual object (e.g., the second device may be used as a handheld controller or other controller to control the first device) and/or the position sensors in both the first and second devices may gather information on the positions of the first and second devices so that as virtual content is being presented to the user with the first device, the relative positions of the first and second devices can be taken into account (e.g., so that a virtual object corresponding to the second device may be accurately placed within a virtual reality world that is being presented to the user with the first device). In general, any suitable action may be taken by devices 10 based on the position sensor information (e.g., calibration operations to account for measured component misalignment, control operations to control the behavior of one device based on the detected positions of the sensor(s), etc.). The operations of FIG. 5 may, if desired, be performed continuously while devices 10 are powered on and being used in system 8.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, a head-mounted device is provided that includes a waveguide having a first position sensor configured to measure a first orientation of the waveguide, the waveguide is configured to receive the image and direct an image to an eye box, and a projector display that displays the image, the projector display has a second position sensor configured to measure a second orientation of the projector display and the projector display is configured to adjust the image adjusted based on the measured first orientation and the measured second orientation.

In accordance with another embodiment, the head-mounted device includes a head-mounted housing that supports the waveguide.

In accordance with another embodiment, the head-mounted housing supports the projector display.

In accordance with another embodiment, the head-mounted device includes a glasses frame that supports the projector display and the waveguide.

In accordance with another embodiment, the glasses frame supports the waveguide in front of the eye box.

In accordance with an embodiment, a head-mounted device operable with a peripheral that has a peripheral position sensor that measures a first position of the peripheral and that has wireless communications circuitry configured to wirelessly transmit the first position, the head-mounted device is provided that includes a head-mounted device housing; and a display configured to display and image, the display is supported by the head-mounted housing and has a display position sensor that measures a second position of the display and the display is configured to adjust the image based at least partly on the wirelessly transmitted first position and the second position.

In accordance with another embodiment, the head-mounted device includes a waveguide configured to supply an image from the display to an eye box.

In accordance with another embodiment, the display includes a projector display that supplies the image to the waveguide.

In accordance with another embodiment, the head-mounted device includes a waveguide position sensor that measures a third position of the waveguide.

In accordance with another embodiment, the projector display is configured to warp the image based at least partly on the measured second position and the measured third position.

In accordance with an embodiment, glasses are provided that include a housing, a waveguide supported by the housing, a display configured to supply an image to the waveguide, the waveguide provides the image to an eye box and the display is configured to adjust the image based on measured misalignment between the display and the waveguide.

In accordance with another embodiment, the housing includes a glasses frame.

In accordance with another embodiment, the display includes a projector display.

In accordance with another embodiment, the glasses include a display position sensor configured to measure a display orientation of the projector display.

In accordance with another embodiment, the display is configured to adjust the image based at least partly on the display orientation.

In accordance with another embodiment, the glasses include a waveguide position sensor configured to measure a waveguide orientation of the waveguide.

In accordance with another embodiment, the display is configured to adjust the image based at least partly on the measured waveguide orientation.

In accordance with another embodiment, the display is configured to adjust the image by warping the image to compensate for image warping due to misalignment between the projector display and the waveguide.

In accordance with another embodiment, the glasses are operable with a peripheral having a position sensor configured to measure a position of the peripheral and the display is configured to adjust the image based at least partly on the measured position of the peripheral.

In accordance with another embodiment, the display position sensor includes a first inertial measurement unit attached to the display and the waveguide position sensor includes a second inertial measurement unit attached to the waveguide.

In accordance with another embodiment, the glasses include a display position sensor configured to measure a display orientation of the projector display, the housing is configured to form a sealed environmental protection enclosure for the display position sensor.

In accordance with another embodiment, the glasses include an environmentally sealed position sensor.

In accordance with another embodiment, the glasses include a position sensor, and a lens that helps prevent the position sensor from being exposed to moisture.

In accordance with another embodiment, the glasses include a position sensor, the waveguide helps prevent the position sensor from being exposed to moisture.

The foregoing is merely illustrative and various modifications can be made to the described embodiments. The foregoing embodiments may be implemented individually or in any combination.

What is claimed is:

1. A head-mounted device, comprising:
a waveguide having a first position sensor configured to measure a first orientation of the waveguide, wherein the waveguide is configured to receive the image and direct an image to an eye box; and
a projector display that displays the image, wherein the projector display has a second position sensor configured to measure a second orientation of the projector display and wherein the projector display is configured to adjust the image adjusted based on the measured first orientation and the measured second orientation.

2. The head-mounted device defined in claim 1 further comprising a head- mounted housing that supports the waveguide.

3. The head-mounted device defined in claim 2 wherein the head-mounted housing supports the projector display.

4. The head-mounted device defined in claim 1 further comprising a glasses frame that supports the projector display and the waveguide.

5. The head-mounted device defined in claim 4 wherein the glasses frame supports the waveguide in front of the eye box.

6. A head-mounted device operable with a peripheral that has a peripheral position sensor that measures a first position of the peripheral and that has wireless communications circuitry configured to wirelessly transmit the first position, the head-mounted device comprising:
a head-mounted device housing; and
a display configured to display and image, wherein the display is supported by the head-mounted housing and has a display position sensor that measures a second position of the display and wherein the display is configured to adjust the image based at least partly on the wirelessly transmitted first position and the second position.

7. The head-mounted device defined in claim 6 further comprising a waveguide configured to supply an image from the display to an eye box.

8. The head-mounted device defined in claim 7 wherein the display comprises a projector display that supplies the image to the waveguide.

9. The head-mounted device defined in claim 8 further comprising a waveguide position sensor that measures a third position of the waveguide.

10. The head-mounted device defined in claim 9 wherein the projector display is configured to warp the image based at least partly on the measured second position and the measured third position.

11. Glasses, comprising:
a housing;
a waveguide supported by the housing;
a display configured to supply an image to the waveguide, wherein the waveguide provides the image to an eye box and wherein the display is configured to adjust the image based on measured misalignment between the display and the waveguide.

12. The glasses defined in claim 11 wherein the housing comprises a glasses frame.

13. The glasses defined in claim 12 wherein the display comprises a projector display.

14. The glasses defined in claim 13 further comprising a display position sensor configured to measure a display orientation of the projector display.

15. The glasses defined in claim 14 wherein the display is configured to adjust the image based at least partly on the display orientation.

16. The glasses defined in claim 15 further comprising a waveguide position sensor configured to measure a waveguide orientation of the waveguide.

17. The glasses defined in claim 16 wherein the display is configured to adjust the image based at least partly on the measured waveguide orientation.

18. The glasses defined in claim 17 wherein the display is configured to adjust the image by warping the image to compensate for image warping due to misalignment between the projector display and the waveguide.

19. The glasses defined in claim 18 wherein the glasses are operable with a peripheral having a position sensor configured to measure a position of the peripheral and wherein the display is configured to adjust the image based at least partly on the measured position of the peripheral.

20. The glasses defined in claim 16 wherein the display position sensor comprises a first inertial measurement unit attached to the display and wherein the waveguide position sensor comprises a second inertial measurement unit attached to the waveguide.

21. The glasses defined in claim 13 further comprising a display position sensor configured to measure a display orientation of the projector display, wherein the housing is configured to form a sealed environmental protection enclosure for the display position sensor.

22. The glasses defined in claim 11 further comprising an environmentally sealed position sensor.

23. The glasses defined in claim 11 further comprising:
a position sensor, and
a lens that helps prevent the position sensor from being exposed to moisture.

24. The glasses defined in claim 11 further comprising a position sensor, wherein the waveguide helps prevent the position sensor from being exposed to moisture.
